(19) United States
(12) Patent Application Publication
(10) Pub. No.: US 2009/0011871 A1
(43) Pub. Date: Jan. 8, 2009

(54) SWING TRAINING AID

(76) Inventor: LAWRENCE A. KELLY, Brighton, MI (US)

Correspondence Address: MCKEE, VOORHEES & SEASE, P.L.C., 801 GRAND AVENUE, SUITE 3200, DES MOINES, IA, 50309-2721, US

(21) Appl. No.: 12/167,274

(22) Filed: Jul. 3, 2008

Related U.S. Application Data
(60) Provisional application No. 60/948,010, filed on Jul. 5, 2007.

(51) Int. Cl. A63B 69/00; G01C 19/00

(52) U.S. Cl. 473/453; 473/461; 33/318

(57) ABSTRACT

A gyroscope assembly is mounted within a sports instrument swing aid. A motor is connected to a rotor within the gyroscope assembly. A power source drives the motor to rotate the rotor. During a forward swing of the swing aid, an angular momentum of the rapidly spinning rotor tends to maintain the swing aid parallel to a plane of the swing. A reaction torque from the gyroscope assembly may be sensed by a player if a player's wrists are rotated in a release, and may also be sensed if a parallel relationship of the swing aid to a plane of the swing is not maintained. The swing aid may be in the form of a bat or racket.

### CROSS REFERENCE TO RELATED APPLICATIONS

This application claims priority under 35 U.S.C. §119(e) to provisional application Ser. No. 60/948,010 filed Jul. 5, 2007, herein incorporated by reference in its entirety.

### BACKGROUND OF THE INVENTION

This invention relates to a sport instrument swing training aid, and more particularly to a swing training aid for a generally horizontal swing plane.

Many sports require a player to swing an instrument to strike a ball, such as baseball, softball, tennis, racquetball, squash, and cricket. In these sports, the ball is normally hit at an elevation above the ground, and sometimes from a bent or crouched position, so that the swing plane is substantially horizontal. In comparison, in golf the ball is hit from the ground or from a tee only 1-2 inches above the ground, by a person in a substantially upright standing position, such that the swing plane has a substantial vertical arc.

Several aspects of a player's swing may substantially affect the outcome of the swing, including a rotation of a player's wrists, and an orientation of a swinging instrument, such as a baseball bat. Ideally, a player should rotate or “release” their wrists shortly before a ball is struck so as to maximize the speed of the bat or racket at the point of impact with the ball, thereby hitting the ball with maximum power. A release which is either too early or too late will reduce the distance and speed that the ball will travel. An orientation of a baseball bat with respect to a desired swing plane may also affect a swing outcome, as certain baseball bat orientations may cause undesirable spin in a ball's trajectory motion, or may cause an undesirable point of contact between a baseball bat and a ball.

Accordingly, a primary objective of the present invention is the provision of a method and apparatus to efficiently and effectively improve a person's swing of a sport instrument in a generally horizontal plane.

Another object of the present invention is the provision of a sport instrument and method for improving a person's ability to hit the ball accurately.

A further objective of the present invention is the provision of a bat or racket for training a player to hit a ball with an effective horizontal swing.

Yet another objective of the present invention is the provision of a bat and racket having a gyroscope for providing training feedback about a user's swing.

Still another objective of the present invention is the provision of a gyroscopic training bat or racket which is economical to manufacture and durable in use.

These and other objectives will become apparent from the following description of the invention.

### SUMMARY OF THE INVENTION

A gyroscope assembly is mounted within a sport instrument swing aid, such as a bat or racket. A motor is connected to a rotor within the gyroscope assembly. A power source drives the motor to rotate the rotor. During a forward swing of the swing aid, an angular momentum of the rapidly spinning rotor tends to maintain the swing aid parallel to a plane of the swing. A reaction torque from the gyroscope assembly may be sensed by a player if a player's wrists are rotated in a release, and may also be sensed if a parallel relationship of the swing aid to a plane of the swing is not maintained. The present invention therefore provides an efficient and effective method and apparatus for improving a swing in a generally horizontal plane through the reactive force feedback to the player.

### BRIEF DESCRIPTION OF THE DRAWINGS

FIG. 1 illustrates an example of a baseball player with an example swing path of a baseball bat swing aid.

FIG. 2 schematically illustrates a gyroscope assembly.

FIG. 3 schematically illustrates the gyroscope assembly mounted inside a baseball bat swing aid.

FIG. 4 schematically illustrates an interior of the baseball bat swing aid.

FIG. 5 schematically illustrates an exterior of the baseball bat swing aid.

FIG. 6 illustrates an example of a tennis player with an example swing path of a tennis racket swing aid.

FIG. 7 schematically illustrates a racket swing aid.

### DETAILED DESCRIPTION OF THE PREFERRED EMBODIMENT

The present invention is directed towards a sport instrument swing aid 10 having a shaft 12 with a hand grip 14 at one end of the shaft 12 and a head or hitting zone 16 at the other end of the shaft. The swing aid 10 includes a gyroscope 18, as discussed in more detail below.

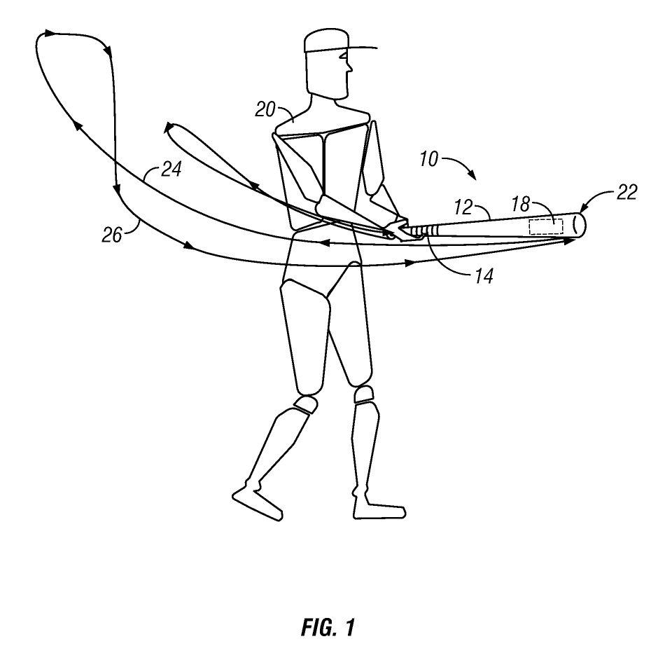

FIG. 1 illustrates an example player 20 and an example swing path 24, 26 of the swing aid 10 in the form of a baseball bat 22. The player 20 holds the bat 22 at the grip 14 of the swing aid 10. The player 20 swings the bat 22 backwards in a backswing 24, and swings the bat 22 forward in a forward swing 26. However, it is understood that a player may perform a backswing 24, then hold the bat 22 in a stationary position, and then perform a forward swing 26. The gyroscope assembly 18 is mounted within the shaft or barrel 12 of the bat 22.

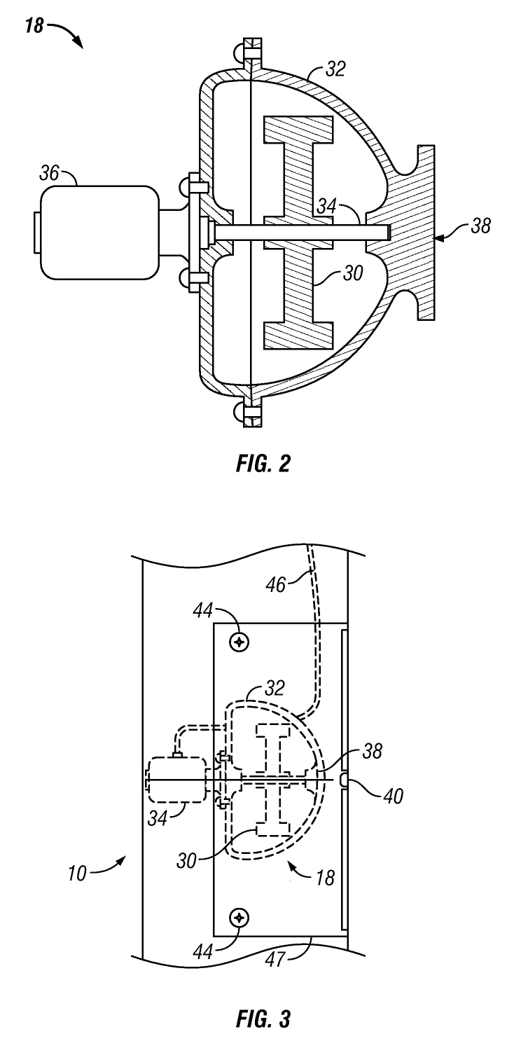

FIG. 2 schematically illustrates the gyroscope assembly 18 of the swing aid 10. The gyroscope assembly 18 includes a rotor 30 mounted for rotation within a fixed housing 32 about an axle or shaft 34. The shaft 34 is straddle mounted at opposite ends in the housing 32. In one example the motor 36 is an electric motor. The motor 36 is connected to the shaft 34, and is operable to rotate the rotor 30 by rotating the shaft 34. A front portion 38 of the gyroscope assembly 18 is aligned with a face of a swing aid 10 so that the front portion 38 corresponds to a point of contact between the swing aid 10 and a ball, such as a baseball or softball.

FIG. 3 schematically illustrates the gyroscope assembly 18 mounted inside the baseball bat swing aid 10. The front portion 38 of the gyroscope assembly 18 aligns with a target 40 on a removable cover 42 or the bat 22. The front cover 42 is secured by a plurality of threaded fasters 44. A pair of wires 46 connects the motor 36 to a power source. In swinging the bat 22, a player aligns the target 40 with a point of contact between the bat 22 and the ball.

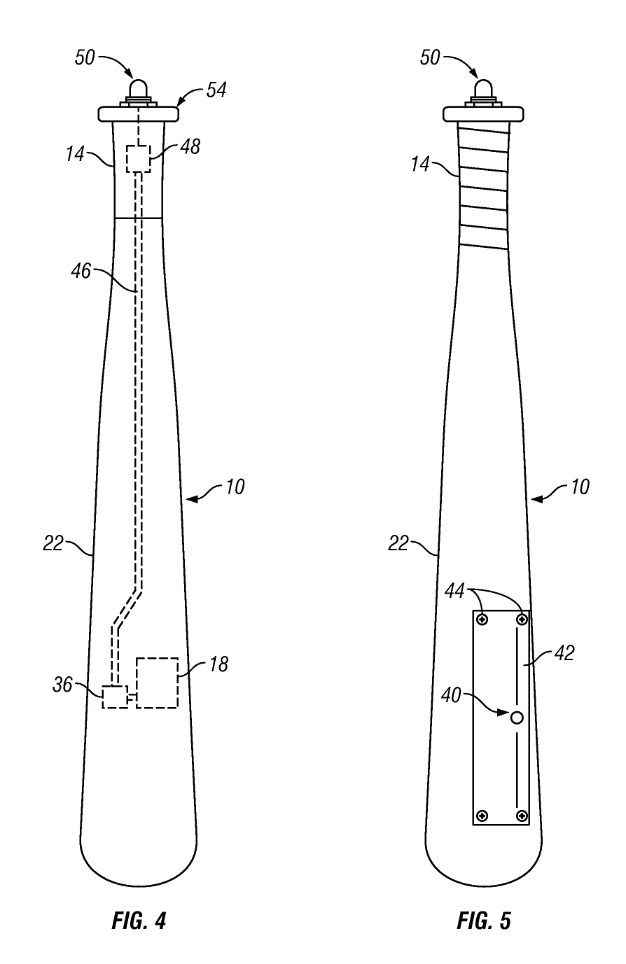

FIG. 4 schematically illustrates an interior of the bat 22. The motor 36 is coupled to the power source 48 via wires 46. The power source is located within the grip portion 14 of the swing aid 10. An ON/OFF switch 50 is located on an end portion 54 of the bat 22. The ON/OFF switch 50 is coupled to the power source 48 to turn the motor 36 ON or OFF. In one example, the power source 48 is a battery or plurality of batteries and the end portion 54 is removable so that the battery or plurality of batteries may be replaced.

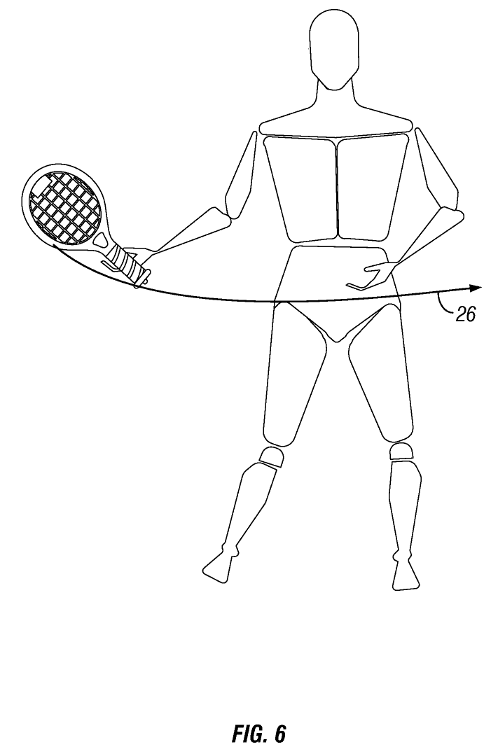

FIG. 5 schematically illustrates an exterior of the bat 22 version of the swing aid 10. The removable cover 42 is secured to the swing aid 10 by the screws 44. The target 40 is located on the removable cover 40. A player aligns the target 40 with a desired point of contact between the bat 22 and the ball.

The swing aid 10 trains a user or player to maintain a swing within a desired swing plane. Before performing a forward swing 26, the user or player turns ON the motor 36 to spin the rotor 30 rapidly. The law of conversation of angular momentum requires a spinning rotor to maintain its plane of rotation unless acted upon by an external torque. If acted upon by an external torque, a reaction torque will occur which may be sensed by the player. During the forward swing 26, an angular momentum of the rapidly spinning rotor 30 tends to maintain the swing aid 10 parallel to a plane of the swing, and resists deviation of the swing aid 10 from the plane of the swing. Thus, a player swinging the swing aid 10 may tell if a swing deviates from a desired swing plane by sensing a reaction torque.

The swing aid 10 also trains a player to avoid an early wrist release. A release occurs when a player rotates his or her wrists at an end portion of the forward swing 26 to orient the swing aid 10 to contact a ball, such as a baseball or softball. It is desirable for the release to occur shortly or immediately before the ball is struck for maximum bat speed at impact, rather than prematurely or late, which adversely affects the swing by reducing bat speed, with a resulting decrease in the distance the ball will travel after impact. The release causes the gyroscope assembly 18 to produce a reaction torque that is sensed by a player. Thus, the reaction torque enables the player to detect the point of release, and to avoid an early or late point of release.

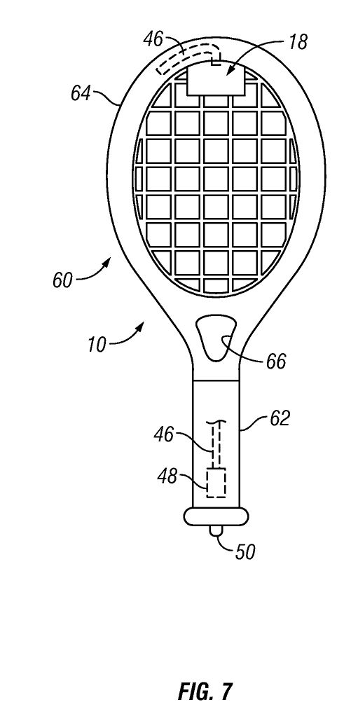

Although a baseball bat 22 swing aid 10 has been described, it is understood that this invention is not limited to baseball, and could also be applied to other sporting devices swung in a generally horizontal plane, such as tennis rackets, squash rackets, racquetball rackets, or cricket bats. For example, FIGS. 6 and 7 schematically illustrate a racket swing aid 60 having the gyroscope assembly 18 mounted on the swing aid 10.

A power source 48 is provided in the handle 62 of the racket 60, with electrical wires 46 extending through or along the racket frame 64 to the gyroscope 18. The gyroscope could also be mounted in the throat 66 of the racket in an alternative embodiment. In use, the back swing path and forward swing path 26 cause the gyroscope to function in the racket 60 in a manner similar to the bat 22 so the player or user can detect the release point of his/her wrist, and learn the ideal timing for releasing the wrist to achieve increased racket speed for hitting the ball with maximum power.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A swing training aid assembly comprising:
a ball bat having a grip at one end and a hitting zone at the opposite end; and
a gyroscope mounted in the bat adjacent the hitting zone.

2. The assembly of claim 1 further comprising a power source in the bat adjacent the hand grip for supplying power to the gyroscope.

3. The assembly of claim 2 further comprising circuitry extending through the bat to provide an electrical connection between the gyroscope and the power source.

4. The assembly of claim 3 further comprising an on/off switch on the bat adjacent the hand grip for activating and deactivating the gyroscope.

5. The assembly of claim 1 wherein the gyroscope generates a reaction torque when a player's wrists release during a swing of the bat.

6. The assembly of claim 1 further comprising a cover removably mounted on the hitting zone of the bat to provide access to the gyroscope.

7. The assembly of claim 1 wherein the cover includes a target.

8. A swing training aid assembly comprising:
a racket having a grip at one end and a hitting zone at the opposite end; and
a gyroscope mounted in the racket adjacent the hitting zone.

9. The assembly of claim 8 further comprising a power source in the racket adjacent the hand grip for supplying power to the gyroscope.

10. The assembly of claim 8 further comprising circuitry extending through the racket to provide an electrical connection between the gyroscope and the power source.

11. The assembly of claim 10 further comprising an on/off switch on the racket adjacent the hand grip for activating and deactivating the gyroscope.

12. The assembly of claim 8 wherein the gyroscope generates a reaction torque when a player's wrist releases during a swing of the racket.

13. A method of training a person for optimum swing of a sport instrument for hitting a moving ball, comprising:
activating a gyroscope mounted in a hitting zone of the instrument;
swinging the instrument in a substantially horizontal plane;
releasing the swinger's wrist or wrists so as to generate a reaction torque by the gyroscope; and
sensing the time of the reaction torque relative to hitting the ball.

14. The method of claim 13 further comprising gripping the instrument with both hands.

15. The method of claim 13 further comprising gripping the instrument with one hand.

16. The method of claim 13 further comprising hitting a baseball or softball.

17. The method of claim 13 further comprising hitting a tennis ball, racquetball, or squash ball.

18. The method of claim 13 further comprising hitting a ball at an elevation between the knees and shoulders.
